(19) United States
(12) Patent Application Publication
(10) Pub. No.: US 2026/0316311 A1
(43) Pub. Date: Oct. 15, 2026

(54) DEVICE AND METHOD FOR CUTTING RODS FOR SMOKING ARTICLES

(71) Applicant: Philip Morris Products S.A., Neuchatel (CH)

(72) Inventors: Cristian VALLUZZI, Milano (IT); José Miguel GONÇALVES LEDO BELO DA COSTA, Milano (IT); Carlo GIANNETTA, Milano (IT)

(73) Assignee: Philip Morris Products S.A., Neuchatel (CH)

(21) Appl. No.: 19/484,497

(22) PCT Filed: May 14, 2024
(86) PCT No.: PCT/EP2024/063222

§ 371 Date: Nov. 14, 2025

(30) Foreign Application Priority Data
May 18, 2023 (EP) 23174156.2

(51) Int. Cl. B26D 1/157; A24D 3/02; B26D 7/06; B26D 7/08; B26D 7/18

(52) U.S. Cl. CPC B26D 1/157; A24D 3/0254; B26D 7/0683; B26D 7/088; B26D 7/1854

(57) ABSTRACT

A device for cutting rods for smoking articles is provided, the device including: a support configured to accommodate a rod for smoking articles; a rotating blade configured to engage and cut into rod pieces the rod for smoking articles accommodated on the support; a scraper mounted close to the rotating blade and being configured to contact and clean the rotating blade; and a magnet mounted close to the rotating blade and being configured to interact with metallic particles located on the rotating blade and/or in the rod for smoking articles.

The present disclosure relates to a device and a method for cutting rods for smoking articles.

The smoking articles herein referred to include both traditional cigarettes and aerosol-generating articles. In the smoking articles, a sensorial medium is combusted or heated to provide flavour to the user.

A traditional burning cigarette is a narrow cylinder containing a combustible material, typically tobacco such as a mixture of tobacco cut filler, that is rolled into paper for smoking. The cigarette is ignited at one end, causing it to smoulder, and the resulting smoke is inhaled via the opposite end. The cigarette may be provided with a filter attached to the rolled combustible material.

An aerosol-generating article or heat-not-burn product comprises an aerosol-generating substrate that is heated rather than combusted. The aerosol-generating substrate is, for instance, a tobacco-free herbaceous or plant-based cast sheet or a biodegradable fiber-based material. Typically in such heated aerosol-generating articles, an aerosol is generated by the transfer of heat from a heat source to a physically separate aerosol-generating substrate or material, which may be located in contact with, within, around or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol.

In a typical manufacturing process of traditional cigarettes, a continuous rod of tobacco wrapped in paper is transversally cut in pieces and each piece may be joined to a filter segment to create the final cigarette. Otherwise, two of said pieces may be joined to a double length filter and the resulting semi-finished product rod is cut in two to create two single cigarettes.

In a typical manufacturing process of aerosol generating articles, an aerosol-generating substrate in a sheet or foil format is gathered into a continuous rod which is then cut into aerosol-generating plugs. These aerosol-generating plugs are components of the aerosol generating articles. For instance, the continuous rod is transversally cut into discrete rods, the discrete rods are transversally cut into plugs which are afterwards combined with other parts, such as a filter, to create the final aerosol-generating articles.

The filters and other parts both of the traditional cigarettes and of the aerosol generating articles may also be manufactured by making a rod and cutting the rod in pieces or plugs. All the rods mentioned above are to be intended as rods for smoking articles.

Cutting of said rods for smoking articles performed through rotating blades is known in the art.

For instance, document U.S. Pat. No. 4,090,602A discloses a rotary drum-shaped article supplying conveyor which is driven to rotate in a counter-clockwise direction and whose periphery is formed with parallel flutes for pairs of coaxial filter cigarettes. The conveyor constitutes a severing conveyor of a filter cigarette making machine. The conveyor receives filter cigarettes of double unit length and transport such cigarettes past a rotary disk-shaped knife which severs each cigarette midway between its ends so that the cigarette yields two coaxial filter cigarettes of unit length.

Document EP3216355A1 discloses a cutting head for cutting rod-shaped pieces in machines for the production of smokers' articles, like pieces of filter or cigarettes. The cutting head comprises a circular blade adapted to cut rod-shaped articles transported in suction flutes of a drum. Scraping discs are provided to mechanically remove residues from the blade.

Document U.S. Pat. No. 3,460,418A1 discloses a disc cutter employed in the manufacturing of cigarettes and cigarette filters. A cleaning device comprises cleaner blades made of flexible steel and movable between a neutral position out of contact with the disc cutter and a cleaning position.

In this technical field, it would be desirable to have a device and a method for cutting rods for smoking articles which improve the quality of the cut rods and of the resulting smoking articles.

It would be desirable to have a device and a method for cutting rods for smoking articles preventing the blades to get dirt and thus also preventing dirtying and/or damaging the cut rods.

Indeed, the rotating blades could be contaminated by the material or materials of the rods. Part of the material/s could remain on the rotating blades, jeopardizing the quality of the ongoing cut as well as possibly staining the rods. This issue is more relevant if the rod comprises glycerin and/or flavours which increase the stickiness and viscosity of the material.

It would be desirable to have a device and a method for cutting rods for smoking articles avoiding a quick wear of the rotating blades and preserving the effectiveness of the cut for a long time.

It would be also desirable to have a device and a method for cutting rods for smoking articles requiring less maintenance and thus reducing the related costs and the costs for manufacturing the smoking articles.

Indeed, if the rotating blades are not cleaned from the stuck material, the effectiveness of the cut may also be compromised and the rotating blades may be subject to wear and tear such that the operation of the cutting device is impaired and maintenance operations and/or replacement of the rotating blades is/are required.

The present disclosure relates to a device for cutting rods for smoking articles. The device comprises a support configured to accommodate a rod for smoking articles and a rotating blade configured to engage and cut into rod pieces the rod for smoking articles accommodated on the support. The device further comprises a scraper mounted close to the rotating blade such as to contact and clean the rotating blade.

The present disclosure also relates to a method for cutting rods for smoking articles. The method comprises: accommodating a rod for smoking articles on a support, engaging a rotating blade with the rod for smoking articles accommodated on the support to cut said rod for smoking articles into rod pieces. The method further comprises: contacting a scraper with the rotating blade to clean said rotating blade.

The method for cutting rods for smoking articles may be performed through the device for cutting rods for smoking articles and/or the device for cutting rods for smoking articles may be configured to carry out the method for cutting rods for smoking articles.

The inventor found that the disclosed device and/or method allow/s to keep the rotating blade clean in an efficient manner while cutting the rods and while manufacturing the smoking articles. Indeed, the scraper removes the residues which are on the blades and which could jeopardize the quality of the cut.

The inventor also found that the disclosed device and/or method allow/s to improve the quality of the cut rods and of the resulting smoking articles and to preserve the effectiveness of the cut for a long time. Therefore, the disclosed device and/or method allow/s to reduce the maintenance operations, the related costs and the costs for manufacturing the smoking articles.

Preferably, the rotating blade is disc shaped. The disc shaped rotating blade rotates about a central rotation axis and is provided with a circumferential cutting edge. Preferably, the rotating blade lies in a plane and said plane is transversal to the rod for smoking articles accommodated on the support. In some other embodiments, the rotating blade may comprise at least one cutting portion mounted on a rotating support.

According to some embodiments, the scraper may be configured to contact and clean the rotating blade while the rotating blade rotates and cuts the rod for smoking articles into rod pieces. The scraper may contact and clean the rotating blade while said rotating blade rotates and cuts the rod for smoking articles into rod pieces. The inventor found that the continuous cleaning performed while the blade is cutting allows to remove particles and dirt as soon as they settle on the blade.

The scraper may be made of metal, for instance brass, or of polymeric material or of a fiber based material, as felt. In some embodiments, the scraper may comprise a brush having bristles contacting the rotating blade and the bristles of the brush may be made of metal, for instance brass, or of polymeric material or of a fiber based material, as felt. In other embodiments, the scraper may comprise a foil having an edge contacting the rotating blade and the foil may be made of metal, for instance brass, or of polymeric material or of a fiber based material, as felt.

Brass proved to be not aggressive on the blade (not leading to blade wearing). The polymeric material and fiber based material should be of the type not leading to any wearing of the blade.

A pressure exerted by the scraper on the blade may be adjusted depending on the kind of materials of the rod.

The device may also comprise a nozzle in fluid communication with a source of gas, optionally air, and the nozzle may be pointed towards the rotating blade to target a jet of gas against the rotating blade while said rotating blade rotates. According to the method, a jet of gas, optionally air, may be targeted against the rotating blade while said rotating blade rotates and cuts the rod. Optionally, the jet of gas targets an area of the rotating blade spaced from the rod for smoking articles under cutting.

In some embodiments, a gas conditioner is configured to control a temperature of the gas from the source of gas. The temperature of the gas from the source of gas may be controlled to keep a temperature of the rotating blade within a temperature range.

The rotating blade lies in a plane and the nozzle may be disposed so that the jet of gas is inclined at an angle between 20° and 70°, optionally 45°, reported to said plane.

The inventor found that inclination of the gas jet helps removing the residues and breaking their clusters and avoids pulverizing and spreading said residues in small particles. The inventor found that the cooling due to the jet of gas reduces the heat of the rotating blade caused by the cutting and so limits the wear of the blade.

The inventor also found that the combined actions of the scraper and of the jet of gas improve greatly the cleaning effectiveness.

The inventor found that the direct effect of the scraper significantly improves the action of the nozzle and vice versa, achieving a joint result that could not be accomplished by the scraper or by the nozzle if they were used separately. Indeed, the cooling also decreases the viscosity of the residues on the blade and so make their removal, carried out by the scraper, much more effective without the need to increase too much the pressure exerted by the scraper on the blade. Reducing the pressure needed to be exerted by the scraper decreases the wear of the blade (and of the coating, in any, for instance DLC coating) as well as improves the working life of the scraper. The temperature and viscosity of the residues should not be lowered too much to avoid hardening of the residues.

Preferably, the temperature of the gas may be controlled to be between 2° and 15°, optionally between 5° and 15 °C. The temperature range may be between 10 °C and 35 °C, optionally between 10 °C and 20 °C. A pressure of the gas may be controlled to be between 2 bar and 10 bar, optionally between 4 bar and 6 bar.

On the other side, by removing the residues layers on the blade, the scraper helps the cooling gas jet to directly contact the metal of the blade and so improves the cooling of the blade.

Preferably, the scraper and the nozzle work on portions of the rotating blade spaced from the support and from the rod being cut to to prevent damaging the rod.

In some embodiments, the scraper and the nozzle work on different portions of the rotating blade. The rotating blade has a rotation axis and the scraper and the nozzle may be placed around the rotation axis. For instance, the scraper and the nozzle are angularly equally spaced around the rotation axis.

The device may also comprise a magnet mounted close to the rotating blade such as to interact with metallic particles located on the rotating blade and/or in the rod. The magnet may be a permanent magnet, for instance made of neodymium, or an electromagnet. The method may also comprise the following step: generating a magnetic field interacting with metallic particles located on the rotating blade and/or in the rod to move said metallic particles away from the rotating blade while said rotating blade rotates and cuts the rod.

The inventor found that the magnet removes any metallic particles and limits the contamination of the rods and the machines.

These metal particles may be either present in the residues/film on the blades or are particles circulating in the air. The effect of the magnet is particularly effective if the same rod for smoking articles comprises metallic parts, such as susceptor elements for heat-not-burn products heated through induction heating, which generate said metallic particles when cut by the blade.

The inventor also found that the combined actions of the magnet with the scraper and/or the jet of gas improve greatly the cleaning effectiveness.

The inventor found that the direct effect of the magnet significantly improves the action of the scraper and/or of the nozzle and vice versa, achieving a joint result that could not be accomplished by the magnet or by the scraper or by the nozzle if they were used separately.

Indeed, the gas jet pressure helps breaking the clusters of residues, making the metallic particles, which are caught into such clusters, accessible to the magnetic force. The gas jet also drives the metallic particles, which are in the air because of the cutting, away from the blade.

Removing the metallic particles which are on the blade helps the cooling action carried out by the gas jet, because these metallic particles may be heated during the cutting process and could participate to the heating of the blade.

Furthermore, removing the metallic particles which are in the residues helps creating holes in the residues and unsticking parts of the residues, making the residues more fragile and so easier to scrub by the scraper.

The scraper, by removing the residues, removes also the metallic particles which are stuck inside, or, at the very least, spread the residues in thinner film from which the metallic particles are more easily extracted by the magnetic force.

Furthermore, taking the metallic particles, which are the hardest components of the residues, out of the residues reduces the damage to the scraper and improves its lifespan.

The inventor also found that the disclosed device and/or method allow/s to improve the quality of the cut rods provided with susceptor elements and of the resulting smoking articles with susceptor elements and to preserve the effectiveness of the cut for a long time.

This way, the susceptor element inside the rod is not deformed/damaged by the cutting and the heating of the final smoking article, when consumed, is not altered by unwanted modification of the shape of the susceptor element due to cutting. Indeed, damaging the susceptor element when cutting may create inefficiency and waste of sensorial media as well as inconsistency of the consumables.

In some embodiments, the magnet, the scraper and the nozzle are placed around the rotation axis. The magnet, the scraper and the nozzle may be angularly equally spaced around the rotation axis. Preferably, with respect to a direction of rotation of the rotating blade about a rotation axis, the nozzle is placed such that the jet of gas hits the rotating blade just downstream of the rod under cutting, the magnet is placed downstream of the nozzle and the scraper is placed downstream of the magnet. While the rotating blade rotates, said rotating blade encounters in succession the rod under cutting, the jet of gas, the magnetic field, the scraper.

The device may also comprise a housing delimiting an accumulation chamber and enclosing the scraper and partly enclosing the rotating blade. The housing may have an aperture facing the support and part of the rotating blade protrudes from the aperture to engage the rod accommodated on the support. In other words, the rotating blade may be partially enclosed in a housing and may protrude from an aperture of the housing.

The inventor found that the housing prevents the debris of the cutting and particles removed from the blade to spread and soil other parts of the apparatus.

If the magnet is part of the device, said magnet may be placed inside the housing.

If the nozzle is part of the device, said nozzle may be placed outside the housing. Optionally, the nozzle points towards the aperture of the housing. The jet of gas may be outside the housing and may point towards the aperture of the housing.

In some embodiments, the device comprises a suction port and a suction device in fluid communication with the suction port. The suction port may be housed in the housing, i.e. in the accumulation chamber. The method may comprise vacuuming debris away from the rotating blade while said rotating blade rotates and cuts the rod.

The inventor found that the suction port allows to evacuate the debris of the cutting and the particles removed from the blade and contained in the housing, as well as drawing into the accumulation chamber external dust and debris generated by the cutting. The dust and debris may be driven towards the aperture of the housing, in the housing and then through the suction port. The dust and debris are trapped into the accumulation chamber where they will be disposed of.

The jet of gas of the nozzle may help driving the dust and debris towards said aperture. If the dust and debris comprises metallic particles, the magnet may help pushing or pulling said metallic particles in the housing and then through the suction port.

Due to the jet of gas with controlled temperature, also the accumulation chamber may be between 2° and 15°, optionally between 5° and 15 °C.

The rotating blade has a first face and a second face opposite the first face and, in some embodiments, the scraper comprises a first scraper contacting the first face and a second scraper contacting the second face. Also the nozzle may comprise a first nozzle targeting the first face and a second nozzle targeting the second face. Also the magnet may comprise a first magnet facing the first face and a second magnet facing the second face. This way, a full cleaning of both faces of the blade is assured.

The support may comprise a conveyor for the rods for smoking articles. An edge of the rotating blade is close to the conveyor in order to cut the rod for smoking articles when said rod for smoking articles is carried by the conveyor under the rotating blade.

In some embodiments, the rod for smoking articles is a continuous rod for smoking articles. The conveyor may comprise an elongated track to accommodate and moving forward the continuous rod for smoking articles. The continuous rod is moved by the conveyor along a direction coincident with a longitudinal development of said continuous rod.

In some other embodiments, the rod for smoking articles is a discrete rod. The conveyor may comprise seats and the seats are configured to accommodate a plurality of discrete rods for smoking articles. The conveyor may comprise a rotating drum and the seats are located on a peripheral portion of the rotating drum. The seat and the rod in the seats may be parallel to a rotation axis of the rotating drum. An edge of the rotating blade may be close to the peripheral portion of the rotating drum in order to cut the rod for smoking articles when said rod for smoking articles is carried by the rotating drum under the rotating blade.

In some embodiments, the device comprises a plurality of rotating blades. The rotating blades of the plurality of rotating blades may be placed side by side. The rotating blades of the plurality of rotating blades may be mounted on a common rotating shaft. The rotating blades of the plurality of rotating blades may be placed in different circumferential positions around the rotating drum. Optionally, the rotating blades of the plurality of rotating blades are all partly enclosed is the same housing.

The rod for smoking articles may comprise a sensorial medium wrapped in a wrapper or additional sections for the smoking articles.

In some embodiments, the sensorial medium comprises tobacco. For instance, the sensorial medium comprises cut filler tobacco. The sensorial medium may also comprise at least one flavorant.

In some other embodiments, the sensorial medium comprises an aerosol generating substrate, optionally a sheet of aerosol-generating substrate, optionally the sheet of aerosol-generating substrate is gathered. The sheet of aerosol-generating substrate may be reconstituted tobacco sheet or a tobacco-free herbaceous or plant-based cast sheet or a biodegradable fiber-based material. The sheet of aerosol-generating substrate may be made from a mixture comprising: fibers, a binder and at least one aerosol forming agent. The at least one aerosol forming agent may comprise a polyhydric alcohol. The polyhydric alcohol may be triethylene glycol, 1,3-butanediol or glycerine or propylene glycol. In some embodiments, the aerosol forming agent comprises monohydric alcohols, optionally menthol; or esters of polyhydric alcohols, optionally glycerol mono-, di-or triacetate; or aliphatic esters of mono-, di-or polycarboxylic acids, optionally dimethyl dodecanedioate, dimethyl tetradecanedioate or triethyl citrate.

An amount of the aerosol forming agent in the sensorial medium may be 10 percent to 80 percent on dry weight basis, optionally between 15 percent and 60 percent, optionally of about 20 percent, optionally of about 50 percent.

In some embodiments, the rod for smoking articles comprises a susceptor element coupled to the sensorial medium and the smoking article is an aerosol-generating article or heat-not-burn product.

The susceptor element may be embedded in the sensorial medium. The susceptor element may extend along the rod for smoking articles. The susceptor element may be a bar, optionally a flat bar or strip, optionally having a rectangular cross section. The susceptor element may be in the middle of the rod (i.e. located at a central longitudinal axis of the rod). The susceptor element may be cut by the rotating blade while cutting the rod for smoking articles.

The inventor found that the disclosed device and method for cutting rods for smoking articles is particularly effective if said rod for smoking articles is for heat-not-burn products and comprises the susceptor element. Indeed, the sensorial medium of heat-not-burn products uses a high concentration of aerosol forming agents, like glycerine, and flavors, increasing the stickiness and viscosity of the aerosol forming substrate. High stickiness and viscosity contribute to dirt the rotating blade of the device for cutting rods for smoking articles.

Furthermore, since also the susceptor element has to be cut by the rotating blade, several other issues arise: the intensified friction due to the cutting of the susceptor element heats the rotating blade, increasing the wear of the blade; the cuts of the susceptor element generate metal particles and metal dust that contaminate the rods and the machine; the heated rotating blade increases the quantity and viscosity of the film of glycerin, flavors etc. remaining on the blade, making even more difficult removing the deposits from the blades.

The inventor found that the action of the scraper of the device and, even more efficiently, the combined action of the scraper with the nozzle and/or the magnet and/or the suction allow/s to keep the rotating blade clean, to improve the quality of the cut rods and of the resulting smoking articles, to avoid quick wear of the rotating blade, to preserve the effectiveness of the cut, etc., even if the rod for smoking articles is for heat-not-burn products and comprises the susceptor element.

The rod for smoking articles may comprise a multiple length smoking article which is cut to obtain single smoking articles. The multiple length smoking article may comprise at least one sensorial medium section and at least one additional section. The multiple length smoking article may be cut at the sensorial medium section or at the additional section.

The present disclosure also relates to an apparatus for manufacturing smoking articles. The apparatus for manufacturing smoking articles may comprise a device for cutting rods for smoking articles.

The device for cutting rods for smoking articles may comprise a support configured to accommodate a rod for smoking articles and a rotating blade configured to engage and cut into rod pieces the rod for smoking articles accommodated on the support. The device further comprises a scraper mounted close to the rotating blade such as to contact and clean the rotating blade.

Preferably, the rotating blade is disc shaped. The disc shaped rotating blade rotates about a central rotation axis and is provided with a circumferential cutting edge. Preferably, the rotating blade lies in a plane and said plane is transversal to the rod for smoking articles accommodated on the support. In some other embodiments, the rotating blade may comprise at least one cutting portion mounted on a rotating support.

According to some embodiments, the scraper may be configured to contact and clean the rotating blade while the rotating blade rotates and cuts the rod for smoking articles into rod pieces.

The scraper may be made of metal, for instance brass, or of polymeric material or of a fiber based material, as felt.

In some embodiments, the scraper may comprise a brush having bristles contacting the rotating blade and the bristles of the brush may be made of metal, for instance brass, or of polymeric material or of a fiber based material, as felt. In other embodiments, the scraper may comprise a foil having an edge contacting the rotating blade and the foil may be made of metal, for instance brass, or of polymeric material or of a fiber based material, as felt.

The device may also comprise a nozzle in fluid communication with a source of gas, optionally air, and the nozzle may be pointed towards the rotating blade to target a jet of gas against the rotating blade while said rotating blade rotates.

In some embodiments, a gas conditioner is configured to control a temperature of the gas from the source of gas.

The rotating blade lies in a plane and the nozzle may be disposed so that the jet of gas is inclined at an angle between 20° and 70°, optionally 45°, reported to said plane.

Preferably, the temperature of the gas may be controlled to be between 2° and 15°, optionally between 5° and 15 °C. A pressure of the gas may be controlled to be between 2 bar and 10 bar, optionally between 4 bar and 6 bar.

Preferably, the scraper and the nozzle work on portions of the rotating blade spaced from the support and from the rod being cut to to prevent damaging the rod.

In some embodiments, the scraper and the nozzle work on different portions of the rotating blade. The rotating blade has a rotation axis and the scraper and the nozzle may be placed around the rotation axis. For instance, the scraper and the nozzle are angularly equally spaced around the rotation axis.

The device may also comprise a magnet mounted close to the rotating blade such as to interact with metallic particles located on the rotating blade and/or in the rod. The magnet may be a permanent magnet, for instance made of neodymium, or an electromagnet.

In some embodiments, the magnet, the scraper and the nozzle are placed around the rotation axis. The magnet, the scraper and the nozzle may be angularly equally spaced around the rotation axis. Preferably, with respect to a direction of rotation of the rotating blade about a rotation axis, the nozzle is placed such that the jet of gas hits the rotating blade just downstream of the rod under cutting, the magnet is placed downstream of the jet of gas and the scraper is placed downstream of the magnet.

The device may also comprise a housing delimiting an accumulation chamber and enclosing the scraper and partly enclosing the rotating blade. The housing may have an aperture facing the support and part of the rotating blade protrudes from the aperture to engage the rod accommodated on the support.

If the magnet is part of the device, said magnet may be placed inside the housing.

If the nozzle is part of the device, said nozzle may be placed outside the housing. Optionally, the nozzle points towards the aperture of the housing.

In some embodiments, the device comprises a suction port and a suction device in fluid communication with the suction port. The suction port may be housed in the housing. The rotating blade has a first face and a second face opposite the first face and, in some embodiments, the scraper comprises a first scraper contacting the first face and a second scraper contacting the second face. Also the nozzle may comprise a first nozzle targeting the first face and a second nozzle targeting the second face. Also the magnet may comprise a first magnet facing the first face and a second magnet facing the second face.

The support may comprise a conveyor for the rods for smoking articles. An edge of the rotating blade is close to the conveyor in order to cut the rod for smoking articles when said rod for smoking articles is carried by the conveyor under the rotating blade.

The conveyor may comprise an elongated track to accommodate and moving forward a continuous rod for smoking articles.

The conveyor may comprise seats and the seats are configured to accommodate a plurality of discrete rods for smoking articles. The conveyor may comprise a rotating drum and the seats are located on a peripheral portion of the rotating drum. The seat and the rod in the seats may be parallel to a rotation axis of the rotating drum. An edge of the rotating blade may be close to the peripheral portion of the rotating drum in order to cut the rod for smoking articles when said rod for smoking articles is carried by the rotating drum under the rotating blade.

In some embodiments, the device comprises a plurality of rotating blades. The rotating blades of the plurality of rotating blades may be placed side by side. The rotating blades of the plurality of rotating blades may be mounted on a common rotating shaft. The rotating blades of the plurality of rotating blades may be placed in different circumferential positions around the rotating drum. Optionally, the rotating blades of the plurality of rotating blades are all partly enclosed is the same housing.

The apparatus for manufacturing smoking articles may comprise: an apparatus for making a plurality of sensorial medium sections, an apparatus for making a plurality of additional sections, a combiner machine configured to axially join the additional sections and the sensorial medium sections to make a plurality of smoking articles.

The device for cutting rods for smoking articles may be part of the apparatus for making the plurality of sensorial medium sections and/or of the apparatus for making the plurality of the additional sections and/or of the combiner machine.

The present disclosure also relates to a process for manufacturing smoking articles. The process for manufacturing smoking articles may comprise a method for cutting rods for smoking articles.

The method for cutting rods for smoking articles may comprise: accommodating a rod for smoking articles on a support, engaging a rotating blade with the rod for smoking articles accommodated on the support to cut said rod for smoking articles into rod pieces. The method further comprises: contacting a scraper with the rotating blade to clean said rotating blade.

The scraper may contact and clean the rotating blade while said rotating blade rotates and cuts the rod for smoking articles into rod pieces.

A pressure exerted by the scraper on the blade may be adjusted depending on the kind of materials of the rod.

A jet of gas, optionally air, may be targeted against the rotating blade while said rotating blade rotates and cuts the rod. Optionally, the jet of gas targets an area of the rotating blade spaced from the rod for smoking articles under cutting.

A temperature of the gas from the source of gas may be controlled to keep a temperature of the rotating blade within a temperature range. The temperature range may be between 10 °C and 35 °C, optionally between 10 °C and 20 °C.

The method may also comprise the following step: generating a magnetic field interacting with metallic particles located on the rotating blade and/or in the rod to move said metallic particles away from the rotating blade while said rotating blade rotates and cuts the rod.

While the rotating blade rotates, said rotating blade may encounter in succession the rod under cutting, the jet of gas, the magnetic field, the scraper.

The rotating blade may be partially enclosed in a housing and may protrude from an aperture of the housing. The jet of gas may be outside the housing and may point towards the aperture of the housing. The jet of gas may be in a direction of cutting.

The method may comprise vacuuming debris away from the rotating blade while said rotating blade rotates and cuts the rod.

The process for manufacturing smoking articles may comprise the following steps: making a plurality of sensorial medium sections; making a plurality of additional sections; combining the additional sections and the sensorial medium sections to make a plurality of smoking articles.

The step of making the plurality of sensorial medium sections and/or the step of making the plurality of additional sections and/or the step of combining the additional sections and the sensorial medium sections may comprise the method for cutting rods for smoking articles.

In some embodiments, making the plurality of sensorial medium sections comprises: coupling a susceptor element to the sensorial medium.

In some embodiments, making the plurality of sensorial medium sections comprises: making a sheet of aerosol-generating substrate, coupling a susceptor element in the form of a continuous band to the sheet of aerosol-generating substrate; gathering the sheet of aerosol-generating substrate with the susceptor element into a continuous rod; wrapping the continuous rod in a wrapper; cutting the continuous rod in the plurality of sensorial medium sections.

In some embodiments, the process may also comprise: cutting the sensorial medium sections in shorter sections to be combined with the additional sections; wherein cutting the sensorial medium sections in shorter sections is carried out through the method for cutting rods for smoking articles.

The present disclosure also relates to a smoking article made through the process for manufacturing smoking articles above disclosed and/or through the apparatus for manufacturing smoking articles above disclosed. Said smoking article may be a burning cigarette or an aerosol-generating article.

As used in the present description, a smoking article is intended to comprise both traditional burning cigarettes and the like, in which a sensorial medium section comprising a sensorial medium, typically tobacco, is ignited and combusted, and heat-not-burn products in which the sensorial medium comprises an aerosol-generating substrate which is heated rather than combusted.

As used in the present description, the sensorial medium is that part of the smoking article generating smoke (through burning in traditional cigarettes) or aerosol (through heating in heat-not-burn products) and providing flavour to the user.

As used in the present description, a rod for smoking article is a semi-finished product of a process for making smoking articles. The rod may comprise at least one sensorial medium section and/or at least one additional section.

As used in the present description, an additional section is a section, other than the sensorial medium section, configured to provide a structural function to the smoking article and/or to change properties of the smoke or aerosol, such as adding further substances or removing substances (filter), diluting smoke or aerosol the with air, changing the temperature of the smoke or aerosol or others. The additional section may comprise one or more elements.

As used in the present description, a susceptor element is an element made of a material (e.g. metal or ceramic) used for its ability to absorb electromagnetic energy and convert it to heat. Susceptor elements are employed in heat-not-burn products which are heated by heating the susceptor material through a heating device comprising an electromagnetic generator. Once a heat-not-burn product with the susceptor element is inserted into the heating device, the heating device generates an alternative magnetic field creating eddy currents on the susceptor. These eddy currents heat the susceptor by Joule effect.

The invention is defined in the claims. However, below there is provided a non-exhaustive list of non-limiting examples. Any one or more of the features of these examples may be combined with any one or more features of another example, embodiment, or aspect described herein.

EX1. A device for cutting rods for smoking articles, the device comprising:
a support configured to accommodate a rod for smoking articles;
a rotating blade configured to engage and cut into rod pieces the rod for smoking articles accommodated on the support;
a scraper mounted close to the rotating blade such as to contact and clean the rotating blade.

EX2. The device according to EX1, wherein the rotating blade is disc shaped; otherwise, the rotating blade comprises at least one cutting portion mounted on a rotating support.

EX3. The device according to EX1 or EX2, wherein the scraper is configured to contact and clean the rotating blade while the rotating blade rotates and cuts the rod for smoking articles into rod pieces.

EX4. The device according to any of EX1 to EX3, wherein the scraper is made of metal, for instance brass, or of polymeric material or of a fiber based material, as felt.

EX5. The device according to any of EX1 to EX4, wherein the scraper comprises a brush having bristles contacting the rotating blade or a foil having an edge contacting the rotating blade.

EX6. The device according to EX5, wherein the bristles of the brush or the foil are made of metal, for instance brass, or of polymeric material or of a fiber based material, as felt.

EX7. The device according to any of EX1 to EX6, comprising a nozzle in fluid communication with a source of gas, the nozzle being pointed towards the rotating blade to target a jet of gas against the rotating blade while said rotating blade rotates.

EX8. The device according to EX7, wherein the gas is air.

EX9. The device according to EX7 or EX8, comprising a gas conditioner configured to control a temperature of the gas from the source of gas.

EX10. The device according to any of EX7 to EX9, wherein the rotating blade lies in a plane and the nozzle is disposed so that the jet of gas is inclined at an angle between 20° and 70°, optionally 45°, reported to said plane.

EX11. The device according to any of EX7 to EX10, wherein the scraper and the nozzle work on portions of the rotating blade spaced from the support and from the rod being cut.

EX12. The device according to any of EX7 to EX11, wherein the scraper and the nozzle work on different portions of the rotating blade.

EX13. The device according to any of EX7 to EX12, wherein the rotating blade has a rotation axis and the scraper and the nozzle are placed around the rotation axis.

EX14. The device according to EX13, wherein the scraper and the nozzle are angularly equally spaced around the rotation axis.

EX15. The device according to any of EX1 to EX14, comprising a magnet mounted close to the rotating blade such as to interact with metallic particles located on the rotating blade and/or in the rod for smoking articles.

EX16. The device according to EX15, wherein the magnet is a permanent magnet, for instance made of neodymium, or an electromagnet.

EX17. The device according to EX15 or EX16 when EX15 is according to any of EX7 to EX14, wherein the magnet, the scraper and the nozzle are placed around the rotation axis.

EX18. The device according to EX17, wherein the magnet, the scraper and the nozzle are angularly equally spaced around the rotation axis.

EX19. The device according to EX17 or EX18, wherein, with respect to a direction of rotation of the rotating blade about a rotation axis, the nozzle is placed such that the jet of gas hits the rotating blade just downstream of the rod under cutting, the magnet is placed downstream of the jet of gas and the scraper is placed downstream of the magnet.

EX20. The device according to any of EX1 to EX19, comprising a housing delimiting an accumulation chamber and enclosing the scraper and partly enclosing the rotating blade. EX21. The device according to EX20 when according to any of EX15 to EX19, wherein the magnet is housed in the housing.

EX22. The device according to EX20 or EX21, wherein the housing has an aperture facing the support, part of the rotating blade protruding from the aperture to engage the rod accommodated on the support.

EX23. The device according to any of EX20 to EX22 when according to any of EX7 to EX14, wherein the nozzle is placed outside the housing.

EX24. The device according to EX23, wherein the nozzle points towards the aperture.

EX25. The device according to any of EX20 to EX24, comprising a suction port, optionally housed in the housing, and a suction device in fluid communication with the suction port.

EX26. The device according to any of EX1 to EX25, wherein the rotating blade lies in a plane, said plane being transversal to the rod for smoking articles accommodated on the support.

EX27. The device according to any of EX1 to EX26, wherein the rotating blade has a first face and a second face opposite the first face, wherein the scraper comprises a first scraper contacting the first face and a second scraper contacting the second face.

EX28. The device according to EX27 when according to any of EX7 to EX14, wherein the nozzle comprises a first nozzle targeting the first face and a second nozzle targeting the second face.

EX29. The device according to EX27 or EX28 when EX27 is according to any of EX15 to EX19, wherein the magnet comprises a first magnet facing the first face and a second magnet facing the second face.

EX30. The device according to any of EX1 to EX29, wherein the support comprises a conveyor for the rods for smoking articles.

EX31. The device according to EX30, wherein the conveyor comprises an elongated track to accommodate and moving forward a continuous rod for smoking articles.

EX32. The device according to EX30 or EX31, wherein the conveyor comprises seats and the seats are configured to accommodate a plurality of discrete rods for smoking articles.

EX33. The device according to any of EX30 to EX32, wherein an edge of the rotating blade is close to the conveyor in order to cut the rod for smoking articles when said rod for smoking articles is carried by the conveyor under the rotating blade.

EX34. The device according to EX30, wherein the conveyor comprises a rotating drum and the seats are located on a peripheral portion of the rotating drum, optionally the seat and the rod in the seats are parallel to a rotation axis of the rotating drum.

EX35. The device according to EX34, wherein an edge of the rotating blade is close to the peripheral portion of the rotating drum in order to cut the rod for smoking articles when said rod for smoking articles is carried by the rotating drum under the rotating blade.

EX36. The device according to any of EX1 to EX35, comprising a plurality of rotating blades.

EX37. The device according to EX36, wherein the rotating blades of the plurality of rotating blades are placed side by side, optionally the rotating blades are mounted on a common rotating shaft.

EX38. The device according to EX36 or EX37 when EX36 is according to EX34 or EX35, wherein the rotating blades of the plurality of rotating blades are placed in different circumferential positions around the rotating drum.

EX39. The device according to any of EX36 to EX38 when EX36 is according to any of EX20 to EX25 and EX34 or EX35, wherein the rotating blades of the plurality of rotating blades are all partly enclosed is the same housing.

EX40. A method for cutting rods for smoking articles, comprising:
accommodating a rod for smoking articles on a support;
engaging a rotating blade with the rod for smoking articles accommodated on the support to cut said rod for smoking articles into rod pieces;
contacting a scraper with the rotating blade to clean said rotating blade.

EX41. The method according to EX40, wherein said method is performed through the apparatus according to any of EX1 to EX39.

EX42. The method according to EX42 or EX41, wherein the scraper contacts and cleans the rotating blade while said rotating blade rotates and cuts the rod for smoking articles into rod pieces.

EX43. The method according to any of EX40 to EX42, further comprising: targeting a jet of gas from the source of gas against the rotating blade while said rotating blade rotates and cuts the rod.

EX44. The method according to EX43, comprising: controlling a temperature of the gas from the source of gas to keep a temperature of the rotating blade within a temperature range.

EX45. The method according to EX44, wherein the temperature of the gas is controlled to be between 2° and 15°, optionally between 5°and 15 °C.

EX46. The method according to EX44 or EX45, wherein the temperature range may be between 10 °C and 35 °C, optionally between 10 °C and 20 °C.

EX47. The method according to any of EX43 to EX46, wherein a pressure of the gas is controlled to be between 2 bar and 10 bar, optionally between 4 bar and 6 bar.

EX48. The method according to any of EX43 to EX47, wherein the jet of gas targets an area of the rotating blade spaced from the rod for smoking articles under cutting.

EX49. The device according to any of EX43 to EX48, wherein the rotating blade is partially enclosed in a housing and protrudes from an aperture of the housing, wherein the jet of gas is outside the housing and points towards the aperture of the housing, optionally in a direction of cutting.

EX50. The method according to any of EX40 to EX49, comprising: generating a magnetic field interacting with metallic particles located on the rotating blade and/or in the rod to move said metallic particles away from the rotating blade while said rotating blade rotates and cuts the rod.

EX51. The method according to any of EX40 to EX50, comprising: vacuuming debris away from the rotating blade while said rotating blade rotates and cuts the rod.

EX52. The method according to any of EX43 to EX49 and according to EX50 and EX51, wherein, while the rotating blade rotates, said rotating blade encounters in succession the rod under cutting, the jet of gas, the magnetic field, the scraper.

EX53. The device according to any of EX1 to EX39 or the method according to any of EX40 to EX52, wherein the rod for smoking articles comprises a sensorial medium wrapped in a wrapper.

EX54. The device or the method according to EX53, wherein the sensorial medium comprises tobacco, optionally cut filler tobacco.

EX55. The device or the method according to EX53 or EX54, wherein the sensorial medium comprises at least one flavorant.

EX56. The device or the method according to EX53, wherein the sensorial medium comprises an aerosol generating substrate, optionally a sheet of aerosol-generating substrate, optionally the sheet of aerosol-generating substrate is gathered.

EX57. The device or the method according to EX56, wherein the sheet of aerosol-generating substrate is reconstituted tobacco sheet or a tobacco-free herbaceous or plant-based cast sheet or a biodegradable fiber-based material.

EX58. The device or the method according to EX56 or EX57, wherein the sheet of aerosol-generating substrate is made from a mixture comprising: fibers, a binder and at least one aerosol forming agent.

EX59. The device or the method according to EX58, wherein the at least one aerosol forming agent comprises a polyhydric alcohol.

EX60. The device or the method according to EX59, wherein the polyhydric alcohol may be triethylene glycol, 1,3-butanediol or glycerine or propylene glycol.

EX61. The device or the method according to any of EX58 to EX60, wherein an amount of the aerosol forming agent in the sensorial medium is 10 percent to 80 percent on dry weight basis, optionally between 15 percent and 60 percent, optionally of about 20 percent, optionally of about 50 percent.

EX62. The device according to any of EX1 to EX39 or the method according to any of EX40 to EX52 or the device or the method according to any of EX53 to EX61, wherein the rod for smoking articles comprises additional sections for the smoking articles.

EX63. The device according to any of EX1 to EX39 or the method according to any of EX40 to EX52 or the device or the method according to any of EX53 to EX62, wherein the rod for smoking articles is a continuous rod or a discrete rod.

EX64. The device or the method according to any of EX53 to EX60, wherein the rod for smoking articles comprises a susceptor element coupled to the sensorial medium, optionally the susceptor element being embedded in the sensorial medium.

EX65. The device or the method according to EX64, wherein the susceptor element extends along the rod for smoking articles.

EX66. The device or the method according to EX64 or EX65, wherein the susceptor element is a bar, optionally a flat bar or strip, optionally having a rectangular cross section. EX67. The device or the method according to any of EX64 to EX66, wherein the susceptor element is cut by the rotating blade while cutting the rod for smoking articles.

EX68. The device according to any of EX1 to EX39 or the method according to any of EX40 to EX52 or the device or the method according to any of EX53 to EX67, wherein the rod for smoking articles comprises a multiple length smoking article which is cut to obtain single smoking articles.

EX69. The device or the method according to EX68, wherein the multiple length smoking article comprises at least one sensorial medium section and at least one additional section.

EX70. The device or the method according to EX69, wherein the multiple length smoking article is cut at the sensorial medium section or at the additional section.

EX71. An apparatus for manufacturing smoking articles, comprising:
an apparatus for making a plurality of sensorial medium sections;
an apparatus for making a plurality of additional sections;
a combiner machine configured to axially join the additional sections and the sensorial medium sections to make a plurality of smoking articles;
at least one device according to any of EX1 to EX39 or any of EX53 to EX70, wherein said at least one device is part of the apparatus for making the plurality of sensorial medium sections and/or is part of the apparatus for making the plurality of the additional sections and/or is part of the combiner machine.

EX72. A process for manufacturing smoking articles, comprising the following steps:
making a plurality of sensorial medium sections;
making a plurality of additional sections;
combining the additional sections and the sensorial medium sections to make a plurality of smoking articles;
wherein making the plurality of sensorial medium sections and/or making the plurality of additional sections and/or combining the additional sections and the sensorial medium sections comprise/s the method according to any of EX40 to EX70.

EX73. The process according to EX72 when the method is according to any of EX64 to EX67, wherein making the plurality of sensorial medium sections comprises: coupling the susceptor element to the sensorial medium.

EX74. The process according to EX73, wherein making the plurality of sensorial medium sections comprises: making a sheet of aerosol-generating substrate, coupling the susceptor element in the form of a continuous band to the sheet of aerosol-generating substrate; gathering the sheet of aerosol-generating substrate with the susceptor element into a continuous rod; wrapping the continuous rod in a wrapper; cutting the continuous rod in the plurality of sensorial medium sections; cutting the sensorial medium sections in shorter sections to be combined with the additional sections; wherein cutting the sensorial medium sections in shorter sections is carried out through the method according to any of EX40 to EX70.

EX75. A smoking article made according to the process of any of EX72 to EX74 and/or through the apparatus of EX71.

EX76. The smoking article of EX75, wherein said smoking article is a burning cigarette or an aerosol-generating article.

Examples will now be further described with reference to the figures in which:

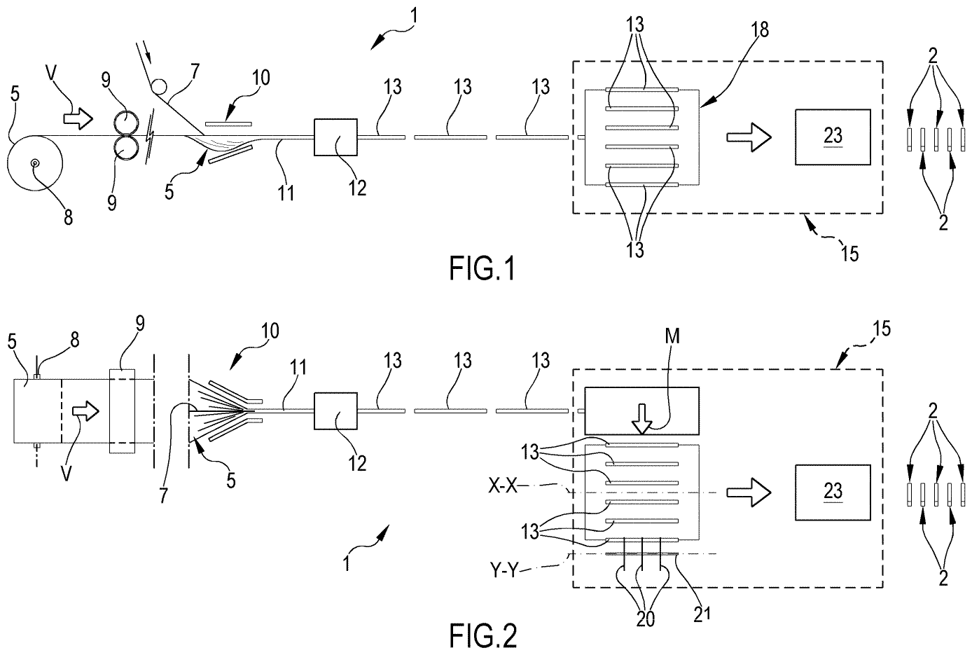

FIG. 1 shows a schematic side view of a portion of an apparatus for manufacturing smoking articles;

FIG. 2 shows a top view of the apparatus of FIG. 1;

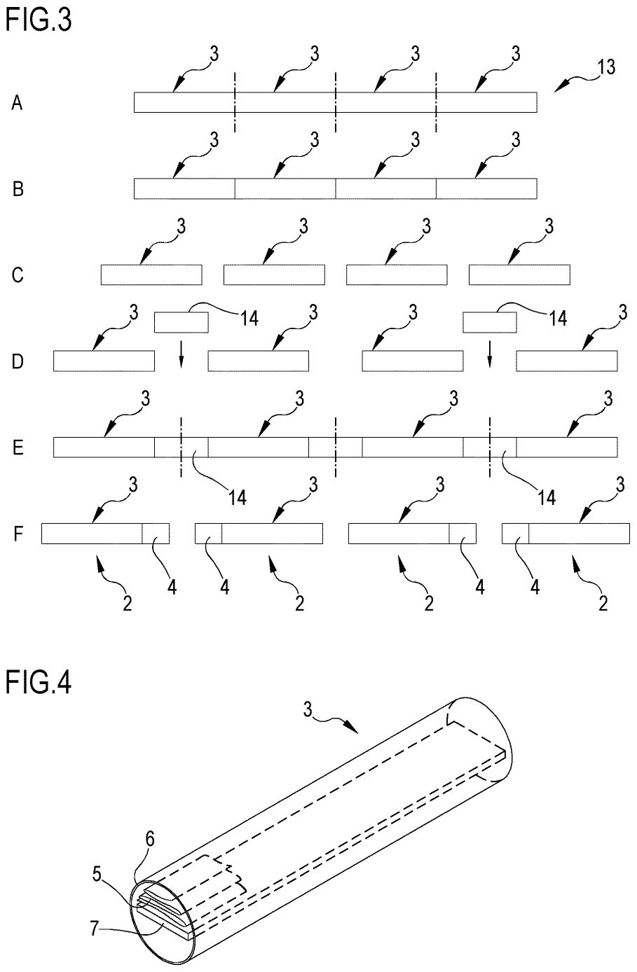

FIG. 3 is a sequence of steps A-F carried out by the apparatus of the preceding Figures;

FIG. 4 is a semi-finished product made through the apparatus of the preceding Figures;

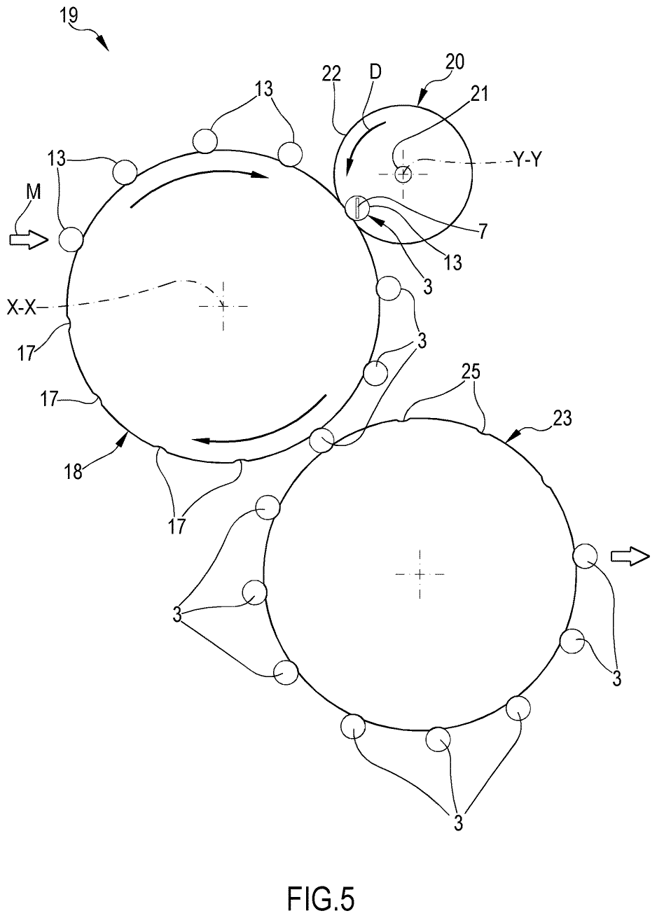

FIG. 5 is a side elevation view of an assembly of the apparatus of FIGS. 1 and 2;

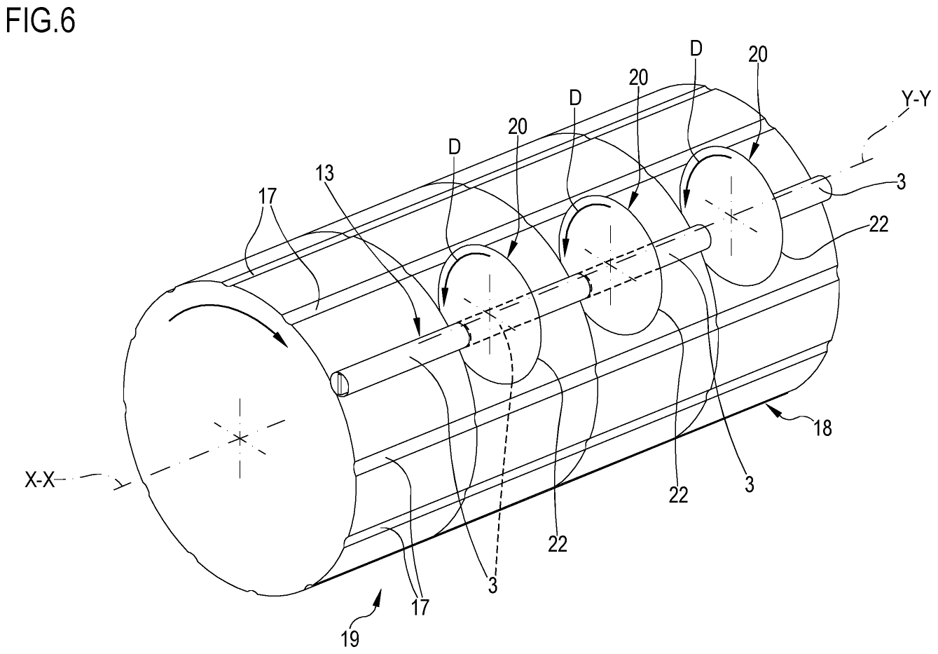

FIG. 6 shows a 3D view of a portion of the assembly of FIG. 3;

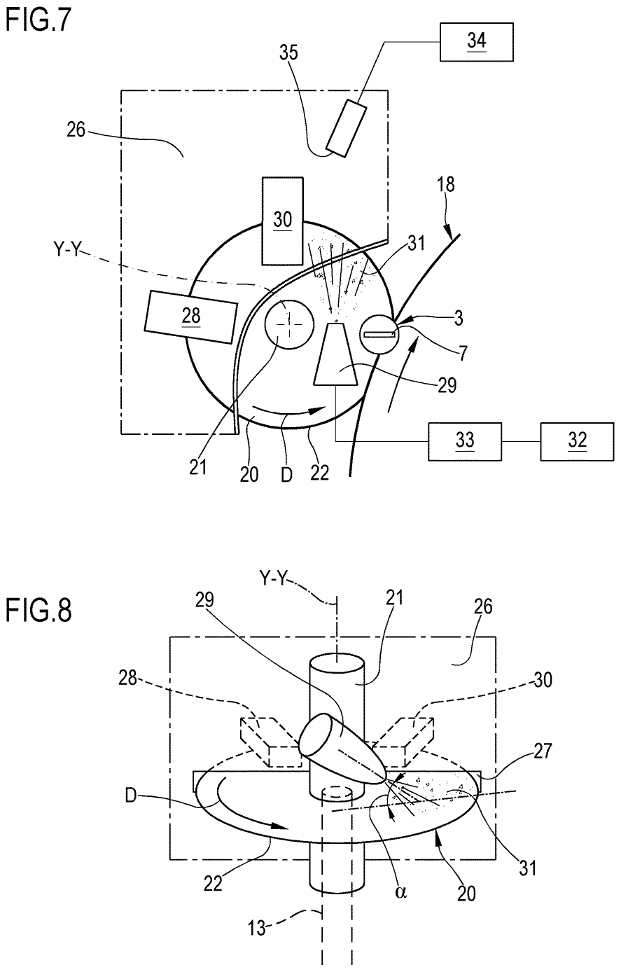

FIG. 7 is a side view of one element of the assembly of FIGS. 3 and 4;

FIG. 8 is another view of the element of FIG. 5.

FIGS. 1 and 2 show an apparatus 1 for making a plurality of sensorial medium sections which is part of an apparatus for manufacturing smoking articles. The apparatus for manufacturing smoking articles as a whole, not depicted in its entirety, is configured to manufacture finished smoking articles. The smoking articles made through the exemplary apparatus herewith detailed are aerosol-generating articles 2 (heat-not-burn products) comprising an aerosol-generating substrate which is heated rather than combusted.

The aerosol-generating article 2 comprises a sensorial medium section 3 joined to an additional section 4 (FIG. 3).

The sensorial medium section 3 comprises a sheet of aerosol-generating substrate 5 which is gathered and wrapped in a wrapper 6 (FIG. 4).

The sheet of aerosol-generating substrate 5 is made from a mixture comprising fibers, a binder and at least one aerosol forming agent. The sensorial medium section 3 shown in the appended FIG. 4 further comprises a susceptor element 7 shaped like a flat bar or strip having a rectangular cross section and extending all along the gathered sheet of aerosol-generating substrate 5. The susceptor element 7 is embedded in the middle of the sensorial medium section 3. The sensorial medium section 3 shown in the appended FIG. 4 is part of an aerosol-generating article 2 configured to be consumed by heating the susceptor element 7 through a heating device, not shown, comprising an electromagnetic generator.

The additional section 4, schematically shown in FIG. 3, usually comprises a filter with a mouthpiece end and may be formed by one or more elements.

During use of the aerosol-generating article 2, volatile compounds of the aerosol forming agents are released from the gathered sheet of aerosol-generating substrate 5 by heat transfer from the susceptor element 7 and are entrained in air drawn, by the user, through the aerosol-generating article 2 from the additional section 4 with the mouthpiece end.

The sheet of aerosol-generating substrate 5 may be a reconstituted sheet obtained through a casting process from the ingredients of the mixture disclosed above, e.g. tobacco powder or other nicotine containing materials, water, fibers, for instance cellulose, and one or more aerosol forming agents.

For instance, the aerosol forming agents comprise polyhydric alcohols, like glycerin, and monohydric alcohols, like menthol. The polyhydric alcohol may also be triethylene glycol, 1,3-butanediol or propylene glycol. The aerosol forming agent may comprises esters of polyhydric alcohols, like glycerol mono-, di-or triacetate, or aliphatic esters of mono-, di-or polycarboxylic acids, like dimethyl dodecanedioate, dimethyl tetradecanedioate or triethyl citrate.

A first step is the manufacturing of a slurry by mixing the above ingredients. In a second step, the slurry is put inside a casting box to be casted by a casting knife on a moving conveyor steel belt to create a continuous sheet of aerosol-generating substrate 5.

The sheet of aerosol-generating substrate 5 is dried and wound on one or more reel-carriers 8 for further processing. An amount of the aerosol forming agent in the aerosol-generating substrate 5 may be 10 percent to 80 percent on dry weight basis, optionally between 15 percent and 60 percent, optionally of about 20 percent, optionally of about 50 percent.

The apparatus 1 for making the plurality of sensorial medium sections 3 shown in FIGS. 1 and 2 comprises the reel-carrier 8 carrying the sheet of aerosol-generating substrate 5.

The sheet of aerosol-generating substrate 5 unwound from the reel-carrier 8 is fed along a feeding path in a feeding direction “V”.

Downstream of the reel-carrier 8, with respect to the feeding direction “V”, the apparatus 1 comprises crimping rollers 9 configured to crimp the sheet of aerosol-generating substrate 5. The crimping process weakens the sheet of aerosol-generating substrate 5 along longitudinal lines and is helpful for folding and gathering the sheet of aerosol-generating substrate 5 into the sensorial medium sections 3 that will fit into the aerosol generating articles 2.

Downstream of the crimping rollers 9, with respect to the feeding direction “V”, the apparatus 1 comprises a folding device 10 which is configured to move the sheet of aerosol-generating substrate 5 from a flat configuration (upstream of the folding device 10) to a gathered rod-shaped configuration (downstream of the folding device 10) and to wrap the wrapper 6 around the gathered of aerosol-generating substrate 5 in order to obtain a continuous sensorial medium rod 11. The folding device 10 may be shaped like a tapered funnel.

Before or while moving the sheet of aerosol-generating substrate 5 to the gathered rod-shaped configuration, a continuous strip or band of susceptor element 7 is coupled to the sheet of aerosol-generating substrate 5 such that, once that the sheet of aerosol-generating substrate 5 is gathered, the susceptor element 7 is located at a central longitudinal axis of the continuous sensorial medium rod 11.

Downstream of the folding device 10, a cutting device 12 cuts the continuous sensorial medium rod 11 in a plurality of four-length sensorial medium sections 13, i.e. sections each having a length that is four times the length of a sensorial medium section of a single aerosol-generating article 2.

Meanwhile, an apparatus for making a plurality of additional sections, not shown in the appended drawings, manufactures a plurality of double-length additional sections 14.

A combiner machine 15, schematically represented in FIGS. 1 and 2, is configured to split the four-length sensorial medium sections 13 in single sensorial medium sections 3, to split the double-length additional sections 14 in single additional sections 4 and to axially join the additional sections 4 and the sensorial medium sections 3 to make a plurality of aerosol-generating articles 2.

An example of process steps carried out by the combiner machine 15 is shown in FIG. 3. Each four-length sensorial medium section 13 is cut in four single sensorial medium sections 3 (A-B). The four axially aligned single sensorial medium sections 3 are spaced apart one from the other (C). Two double length additional sections 14 are placed between two sensorial medium sections 3 and joined to said two sensorial medium sections 3 (D-E) to form two double-length aerosol-generating articles 2. Each of the two double-length aerosol-generating articles 2 is cut at the respective double length additional sections 14 to obtain four single aerosol-generating articles 2 (F).

As shown in FIG. 2, a transfer device 16 moves in sequence the four-length sensorial medium sections 13, that come from the cutting device 12 and lie aligned along an elongated track, in respective seats 17 that are located on a peripheral portion of a rotating drum 18 (arrow “M”, FIGS. 2 and 5). The seats 17 and the four-length sensorial medium sections 13, once accommodated in the seats 17, are parallel to a rotation axis “X-X” of the rotating drum 18. The four-length sensorial medium sections 13 may be retained in the seats 17 by suction.

The rotating drum 18 is part of a device 19 for cutting rods for smoking articles, wherein the four-length sensorial medium sections 13 are discrete rods for smoking articles to be cut by the device 19. The device 19 for cutting rods for smoking articles further comprises three rotating blades 20 configured to engage and cut into rod pieces the four-length sensorial medium sections 13 accommodated on the rotating drum 18. The three rotating blades 20 cut each four-length sensorial medium section 13 (FIG. 3-step A) into the four single sensorial medium sections 3 (FIG. 3-step B).

The three rotating blades 20 are disc shaped and are mounted on a common shaft 21 operatively coupled to a motor, not shown, configured to rotate the common shaft 21 and the three rotating blades 20 about a rotation axis “Y-Y”. The common shaft 21 and the rotation axis “Y-Y” stand parallel to the rotation axis “X-X” of the rotating drum 18. Each disc shaped rotating blade 20 lies in a plane orthogonal to the respective rotation axis “Y-Y”, to the rotation axis “X-X” of the rotating drum 18 and also to the four-length sensorial medium sections 13 accommodated in the seats 17. In some other embodiments, not shown in the appended Figures, the rotating blades 20 of may be placed in different circumferential positions around the rotating drum 18. For instance, a plurality of shafts 21 carry a plurality of rotating blades 20.

In other embodiments, not shown in drawings, the rotating blade may comprise one cutting portion or a plurality of cutting portions mounted on a rotating support. The cutting portion or portions is/are stable on the support and rotate/s together with the support.

A mutual position of the rotating drum 18 and of the three rotating blades 20 is such that an edge 22 of each rotating blade 20 is close to the peripheral portion of the rotating drum 18 to engage and cut the four-length sensorial medium sections 13 when said four-length sensorial medium sections 13 are carried one by one under the rotating blades 20 by the rotation of the rotating drum 18, as shown in FIGS. 4 and 5. Therefore, the device 19 for cutting rods for smoking articles is configured to perform the step from A to B of FIG. 3.

The combiner machine 15 may comprise further rotating drums arranged in cascade one after the other and coupled to further devices, which are represented in FIG. 2 by a rectangle 23. These further rotating drums and further devices are configured to carry out the process steps C to F outlined in FIG. 3. FIG. 5 shows, by way of non-limiting example, one auxiliary rotating drum 24 provided with respective seats 25. The auxiliary rotating drum 24 is placed side by side to the rotating drum 18 and receives and carries the four single sensorial medium sections 3 cut by the device 19 for cutting rods for smoking articles.

The device 19 for cutting rods for smoking articles comprises a housing 26 partly enclosing the rotating blades 20. A portion of the housing 26 is shown in FIGS. 7 and 8. The housing 26 is located close to the rotating drum 18 and is open towards the rotating drum 18 or presents apertures 27 facing the rotating drum 18. Each rotating blade 20 is partly housed in the housing 26 and partly protrudes from the housing 26 or from the respective aperture 27. In the example embodiment shown in FIGS. 7 and 8, the common shaft 21 and major portions of the rotating blades 20 lie outside the housing 26 and a minor portion of each rotating blade 20 is placed in the housing 26. The major portion of each rotating blade 20 protrudes from the aperture 27 to engage the sensorial medium sections 3 accommodated on the rotating drum 18. The housing 26 delimits internally an accumulation chamber for dust and debris.

The device 19 for cutting rods for smoking articles further comprises an assembly configured to clean each rotating blade 20 while the rotating blades 20 are cutting the four-length sensorial medium sections 13 and to remove dust and debris.

In the example embodiment shown in the appended Figures, said assembly comprises two scrapers 28, two nozzles 29 and two magnets 30 operatively coupled to each rotating blade 20. Each rotating blade 20 has a first face and a second face opposite the first face. A first scraper 28, a first nozzles 29 and a first magnet 30 are operatively coupled to the first face and a second scraper 28, a second nozzles 29 and a second magnet 30 are operatively coupled to the second face of the same rotating blade 20.

For sake of simplicity and clarity, the appended FIGS. 7 and 8 show only the scraper 28, the nozzle 29 and the magnet 30 on one face of one rotating blade 20 and the following description refers to said FIGS. 7 and 8.

The scraper 28 comprises a brush having metal bristles contacting and cleaning the face of the rotating blade 20 while the rotating blade 20 rotates and cuts the four-length sensorial medium sections 13 into rod pieces. The scraper 28 is enclosed by the housing 26 and entirely housed in the accumulation chamber. In alternative embodiments, not shown in Figures, the scraper 28 is a metal foil having an edge contacting the face of the rotating blade 20. The foil or the bristles of the brush may also be made of other materials, like polymeric material or fiber based material, as felt.

The nozzle 29 is located outside the housing 26 and is pointed towards the face of the rotating blade 20 to target a jet of gas 31, e.g. air, against said face while the rotating blade 20 rotates and cuts the four-length sensorial medium section 13. The nozzle 29 is disposed so that the jet of gas 31 is inclined at an angle “a” of 45° reported to the laying plane of the rotating blade 20. The nozzle 29 is disposed so that the jet of gas 31 points towards the aperture 27 and in a direction of cutting (FIG. 8). With respect to a direction of rotation of the rotating blade 20 about its rotation axis “Y-Y”, the nozzle 29 is placed such that the jet of gas 31 hits the rotating blade 20 just downstream of the four-length sensorial medium section 13 under cutting. The nozzle 29 is in fluid communication with a source of gas 32 and a gas conditioner 33 is configured to control a temperature of the gas from the source of gas 32 (FIG. 7). The temperature of gas is controlled to be about 10 °C and a pressure of the gas is controlled to be about 5 bar. This way, a temperature of the rotating blade 20 may be controlled to be within a temperature range, for instance between 10 °C and 20 °C.

The magnet 30 is an electromagnet and is mounted in the housing 26 close to the rotating blade 20 such as to interact with metallic particles located on the rotating blade 20 and/or in the four-length sensorial medium sections 13 under cutting and moving said metallic particles away from the rotating blade 20 while said rotating blade 20 rotates and cuts the four-length sensorial medium section 13. The metallic particles may come from the cut of the susceptor element 7 embedded in the sensorial medium and extending along the four-length sensorial medium sections 13. The magnet may also be a permanent magnet, for instance made of neodymium.

The magnet 30, the scraper 28 and the nozzle 29 are placed around the rotation axis “Y-Y”, for instance angularly equally spaced around the rotation axis “Y-Y”. In the embodiment shown in the appended Figures, with respect to a direction of rotation “D” of the rotating blade 20 about the rotation axis “Y-Y”, the nozzle 29 is placed such that the jet of gas 31 hits the rotating blade 20 just downstream of the four-length sensorial medium section 13 under cutting, the magnet 30 is placed downstream of the jet of gas 31 and the scraper 28 is placed downstream of the magnet 30 (FIGS. 7 and 8). While the rotating blade 20 rotates, said rotating blade 20 encounters in succession the four-length sensorial medium section 13 under cutting, the jet of gas 31, the magnetic field generated by the magnet 30 and the scraper 28.

The device 19 for cutting rods for smoking articles further comprises a suction device 34 in fluid communication with a suction port 35 which opens inside the housing 26, i.e. in the accumulation chamber (FIG. 7). The suction device 34 is configured to vacuum debris away from the rotating blade 20 while said rotating blade 20 rotates and cuts the four-length sensorial medium section 13.

The device 19 for cutting rods for smoking articles disclosed above and depicted in the appended Figures is configured to cut the four-length sensorial medium sections 13, i.e. to cut discrete rods.

A device 19 for cutting rods for smoking articles according to the invention may be also implemented to cut each of the two double-length aerosol-generating articles 2 to obtain the four single aerosol-generating articles 2 of FIG. 3 (E-F). This cuts are carried out by the device 19 at the respective double length additional sections 14.

Also the cutting device 12 of FIGS. 1 and 2 that cuts the continuous sensorial medium rod 11 in the plurality of four-length sensorial medium sections 13 may be a device 19 for cutting rods for smoking articles according to the invention, i.e. provided with the scraper 28 and possibly with the nozzle 29 and/or the magnet 30. In this embodiment, the support comprises a conveyor having an elongated track to accommodate and moving forward the continuous sensorial medium rod 11 and the rotating blade or blades 20 of the device 19 may be shaped to perform the proper cutting of said advancing continuous sensorial medium rod 11.

A device 19 for cutting rods for smoking articles according to the invention may also be part of the apparatus for making the plurality of additional sections, not shown. For instance, the device 19 is configured to cut a continuous rod of filter material.

A device 19 for cutting rods for smoking articles according to the invention may also be part of an apparatus for making traditional burning cigarettes. For instance, the device 19 may be implemented to cut a continuous rod of tobacco cut filler with flavorants wrapped in paper wrapper.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A +5 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-13. (canceled)

14. A device for cutting rods for smoking articles, the device comprising:
a support configured to accommodate a rod for smoking articles;
a rotating blade configured to engage and cut into rod pieces the rod for smoking articles accommodated on the support;
a scraper mounted close to the rotating blade and being configured to contact and clean the rotating blade; and
a magnet mounted close to the rotating blade and being configured to interact with metallic particles located on the rotating blade and/or in the rod for smoking articles.

15. The device according to claim 14, wherein the scraper comprises a brush having bristles contacting the rotating blade or a foil having an edge contacting the rotating blade.

16. The device according to claim 14, further comprising a nozzle in fluid communication with a source of gas, the nozzle being pointed towards the rotating blade to target a jet of gas against the rotating blade while the rotating blade rotates.

17. The device according to claim 16, wherein the rotating blade lies in a plane and the nozzle is disposed so that the jet of gas is inclined at an angle (a) between 20° and 70° reported to the plane.

18. The device according to claim 16, wherein, with respect to a direction of rotation of the rotating blade about a rotation axis (Y-Y), the nozzle is placed such that the jet of gas hits the rotating blade just downstream of the rod under cutting, the magnet is placed downstream of the jet of gas, and the scraper is placed downstream of the magnet.

19. The device according to claim 14, further comprising:
a housing delimiting an accumulation chamber and enclosing the scraper and partly enclosing the rotating blade;
a suction port housed in the housing; and
a suction device in fluid communication with the suction port.

20. The device according to claim 14,
further comprising a nozzle in fluid communication with a source of gas, the nozzle being pointed towards the rotating blade to target a jet of gas against the rotating blade while the rotating blade rotates,
wherein the housing has an aperture facing the support,
wherein part of the rotating blade protrudes from the aperture and is configured to engage the rod accommodated on the support, and
wherein the nozzle is disposed outside the housing and points towards the aperture.

21. The device according to claim 14,
wherein the support comprises a conveyor for the rods for smoking articles, the conveyor comprising seats and the seats are configured to accommodate a plurality of discrete rods for smoking articles, and
wherein the conveyor further comprises a rotating drum and the seats are located on a peripheral portion of the rotating drum.

22. A method for cutting rods for smoking articles, comprising:
accommodating a rod for smoking articles on a support;
engaging a rotating blade with the rod for smoking articles accommodated on the support to cut the rod for smoking articles into rod pieces;
contacting a scraper with the rotating blade to clean the rotating blade; and
generating a magnetic field interacting with metallic particles located on the rotating blade and/or in the rod to move the metallic particles away from the rotating blade while the rotating blade rotates and cuts the rod.

23. The method according to claim 22, further comprising targeting a jet of gas from a source of gas against the rotating blade while the rotating blade rotates and cuts the rod.

24. The method according to claim 23,
further comprising controlling a temperature of the gas from the source of gas to keep a temperature of the rotating blade within a temperature range,
wherein the temperature of the gas is controlled to be between 2° and 15°.

25. The method according to claim 22, further comprising vacuuming debris away from the rotating blade while the rotating blade rotates and cuts the rod.

26. The method according to claim 22, wherein, while the rotating blade rotates, the rotating blade encounters in succession the rod under cutting, the jet of gas, the magnetic field, and the scraper.
